(19) United States
(12) Patent Application Publication
(10) Pub. No.: US 2009/0031564 A1
(43) Pub. Date: Feb. 5, 2009

(54) METHOD OF REPAIRING A SHROUD SEGMENT OF A GAS TURBINE

(76) Inventor: Reinhold Meier, Dorfen (DE)

Correspondence Address: GREER, BURNS & CRAIN, 300 S WACKER DR, 25TH FLOOR, CHICAGO, IL, 60606, US

(21) Appl. No.: 12/093,811

(22) PCT Filed: Nov. 14, 2006
(86) PCT No.: PCT/DE06/01993

§ 371 Date: Sep. 3, 2008

(30) Foreign Application Priority Data
Nov. 24, 2005 (DE) 10 2005 055 984.0

(51) Int. Cl. B23P 6/00

(52) U.S. Cl. 29/888.021

(57) ABSTRACT

A method for repairing a shroud segment of a gas turbine, in particular of an aircraft engine, having the steps: a) provision of a shroud segment to be repaired; b) removal of a damaged radially inner section of the shroud segment, so that after the removal of the damaged section the shroud segment has an inner radius; c) manufacture of a replacement section for the shroud segment, the replacement section having an outer radius matched to the inner radius of the shroud segment; d) alignment of the replacement section and the shroud segment; and e) joining of the replacement section to the shroud segment, the replacement section and the shroud segment being first welded to one another for this purpose at their edges in gas-tight fashion in a vacuum, and the surfaces of the replacement section and the shroud segment being subsequently diffusion-bonded to one another by hot isostatic pressing.

The present invention relates to a method for repairing a shroud segment of a gas turbine.

Modern gas turbines, in particular aircraft engines, must meet the most stringent demands with regard to reliability, weight, performance, economics, and lifespan. In the development of gas turbines, the selection of material, the search for new suitable materials, and the search for new manufacturing and repair methods all play a decisive role.

In order to increase performance, it is important to optimize all components and subsystems. In aircraft engines, a particularly problematic area here is the maintenance of a minimum gap between the rotating rotor blades and the stationary housing of a high-pressure compressor or high-pressure turbine. This is because the highest temperatures and largest temperature gradients occur in high-pressure compressors and high-pressure turbines, making gap maintenance more difficult. Inter alia, this is also due to the fact that in compressor rotor blades and high-pressure turbine rotor blades, as a rule shrouds like the ones used in low-pressure turbines are not present.

As was just mentioned, the rotor blades in compressors and in high-pressure turbines do not have a shroud. Therefore, ends or tips of the rotating rotor blades are exposed to direct frictional contact with the fixed housing, in what is known as blade rubbing. Such rubbing of the blade tips results from manufacturing tolerances when a minimum radial gap is set. Because the frictional contact of the blade tips causes material to be removed, an undesirable gap enlargement can result over the entire circumference of the housing and the rotor.

In order to minimize wear on the blade tips during their rubbing in the stationary housing, it is already known from the prior art to provide what are known as run-in coatings in the housing in which the blade tips of the rotor blades can run in. Such run-in coatings are standardly allocated to what are called shroud segments of the housing, namely radially internal segments of the shroud segments, facing the blade tips. Shroud segments in the housing that act as bearers for run-in coatings are also called shrouds.

During operation of the gas turbine, such shroud segments or shrouds are subject to wear, so that they must be either exchanged or repaired during maintenance work. According to standard practice, shroud segments of gas turbines are repaired in that radially inner surfaces of the shroud segments into which the rotor blades can run in during operation of the gas turbine are coated by low-pressure plasma spraying or by high-speed flame spraying. However, in the case both of low-pressure plasma spraying and high-speed flame spraying, repair of the shroud segments is possible only to a relatively limited extent, and the low achievable stability is a problem.

On the basis of the above, the present invention is based on the problem of creating a new method for repairing a shroud segment of a gas turbine.

This problem is solved by a method for repairing a shroud segment of a gas turbine according to claim 1. The method according to the present invention comprises at least the following steps: a) provision of a shroud segment that is to be repaired; b) removal of a damaged radially inner section of the shroud segment, such that after removal of the damaged section the shroud segment has a defined inner radius; c) manufacture of a replacement section for the shroud segment, the replacement section having an outer radius matched to the inner radius of the shroud segment; d) alignment of the replacement section and the shroud segment; e) joining of the replacement section to the shroud segment; for this purpose, first the replacement section and the shroud segment are welded to one another at their edges in gas-tight fashion in a vacuum; subsequently, the surfaces of the replacement section and the shroud segment are diffusion-bonded to one another by hot isostatic pressing.

The present invention provides a completely new type of method for repairing shroud segments of a gas turbine. The replacement section manufactured and used for the repair of a shroud segment can be provided with a high degree of adhesive strength to the shroud segment via a diffusion bond, as well as with a high heat exchange strength and ductility. The replacement section can be made of a monocrystalline material and can have a lower thermal expansion and heat conductivity than does the base material of the shroud segment.

Preferably, before the alignment of the replacement section and the shroud segment, the replacement section and the shroud segment are activated at their contact surfaces by blasting, in particular abrasive oxide blasting.

According to an advantageous development of the present invention, after the alignment of the replacement section and the shroud segment, and before they are joined, the replacement section and the shroud segment are fixed in their alignment to one another by spot welding.

Preferred developments of the present invention result from the subclaims and the following description. An exemplary embodiment of the present invention is explained in more detail below, without limitation to this example.

The present invention relates to a method for repairing shroud segments situated in the housing of a gas turbine, which preferably act as bearer structures for run-in coatings.

In order to repair a shroud segment, after the provision of the shroud segment that is to be repaired a damaged, radially inner section of said segment is removed, in such a way that after this removal the shroud segment to be repaired has a defined inner radius or inner diameter. The damaged section of the shroud segment can for example be removed from the shroud segment by boring.

If necessary, before the removal of the damaged section from the shroud segment, cooling air bores or cracks are sealed by welding.

After the removal of the damaged section of the shroud segment that is to be repaired, a replacement section is then made for the shroud segment, in such a way that the replacement section has an outer radius or outer diameter that is matched to the inner radius or inner diameter of the shroud segment after the damaged section has been removed. The replacement section is preferably manufactured by casting, such as fine casting, or by powder-metallurgical injection molding (metal injecting molding).

The shroud segment with the damaged section removed, as well as the manufactured replacement section, are then aligned relative to one another. Before the alignment of the replacement section and the shroud segment, there preferably takes place an activation of surfaces of the replacement section and the shroud segment that will contact one another in the aligned state. The activation preferably takes place by abrasive blasting. If warranted, the replacement section and the shroud segment can also be coated on their contact surfaces with nickel, with a layer thickness between 0.003 mm and 0.005 mm.

After the alignment of the replacement section and the shroud segment, the replacement section is joined to the shroud segment; after the alignment but before the joining, the replacement section and the shroud segment are preferably fixed in their alignment to one another by spot welding. In order to join the replacement section to the shroud segment, first the replacement section and the shroud segment are welded to one another in gas-tight fashion in a vacuum, preferably using electron beam welding or laser beam welding. The gas-tight welding takes place at the edges between the replacement section and the shroud segment. After the gas-tight welding, the surfaces of the replacement section and the shroud segment are then bonded to one another by hot isostatic pressing.

After the joining, there preferably takes place a checking or inspection of the bond between the replacement section and the shroud segment; this check can be carried out in particular using x-rays, ultrasound inspection, or thermographic inspection. After the joining, and, if warranted, after the checking of the bond, a final contour processing of the repaired shroud segment can be carried out; here, a run-in coating or heat insulating layer can be applied onto a radially inner surface of the repaired shroud segment, and thus to a radially inner surface of the replacement section.

The replacement section manufactured for the repair of a shroud segment can be made of a material different from that of the shroud segment. Thus, the replacement section can for example be made of a monocrystalline material. In selecting the material for the replacement section, care need only be taken that this material have a good adhesive strength to the shroud segment, as well as a high degree of thermal exchange strength and ductility.

1. A method for repairing a shroud segment of a gas turbine, in particular of an aircraft engine, having at least the following steps:
a) provision of a shroud segment to be repaired;
b) removal of a damaged radially inner section of the shroud segment, in such a way that after the removal of the damaged section the shroud segment has a defined inner radius;
c) manufacture of a replacement section for the shroud segment, the replacement section having an outer radius matched to the inner radius of the shroud segment;
d) alignment of the replacement section and the shroud segment; and
e) joining of the replacement section to the shroud segment, the replacement section and the shroud segment being first welded to one another for this purpose at their edges in gas-tight fashion in a vacuum, and the surfaces of the replacement section and the shroud segment being subsequently diffusion-bonded to one another by hot isostatic pressing.

2. The method as recited in claim 1, wherein the replacement section is manufactured by casting.

3. The method as recited in claim 1 wherein the replacement section is manufactured by powder-metallurgical injection molding.

4. The method as recited in claim 1, wherein before the alignment of the replacement section and the shroud segment, the replacement section and the shroud segment are activated at their contact surfaces, preferably by blasting.

5. The method as recited in claim 1, wherein before the alignment of the replacement section and the shroud segment, the replacement section and the shroud segment are coated on their contact surfaces with nickel, preferably with a layer thickness from 0.003 mm to 0.005 mm.

6. The method as recited in claim 1, wherein after the alignment of the replacement section and the shroud segment, and before they are joined, the replacement section and the shroud segment are fixed in their alignment to one another by spot welding.

7. The method as recited in claim 1, wherein after the joining of the replacement section and the shroud segment, a contour processing of the repaired shroud segment is carried out.

8. The method as recited in claim 1, wherein after the joining of the replacement section and the shroud segment, a run-in coating is applied onto a radially inner surface of the repaired shroud segment, and thus of the replacement section.

9. The method as recited in claim 1, wherein after the joining of the replacement section and the shroud segment, a heat-insulating layer is applied onto a radially inner surface of the repaired shroud segment, and thus of the replacement section.

10. The method as recited in claim 1, after the joining of the replacement section and the shroud segment, the bond between the replacement section and the shroud segment is checked using x-rays, ultrasound, or thermography.
